(19) United States
(12) Patent Application Publication
(10) Pub. No.: US 2013/0023207 A1
(43) Pub. Date: Jan. 24, 2013

(54) Wireless Communication User System

(71) Applicants: Kuo-Yi Chen, New Taipei City (TW); Yin-Yu Chen, New Taipei City (TW)

(72) Inventors: Kuo-Yi Chen, New Taipei City (TW); Yin-Yu Chen, New Taipei City (TW)

(21) Appl. No.: 13/454,065

(22) Filed: Apr. 23, 2012

(30) Foreign Application Priority Data
Jul. 19, 2011 (TW) 100125433

(51) Int. Cl. H04B 5/00

(52) U.S. Cl. 455/41.1

(57) ABSTRACT

A wireless communication user system for a wireless communication system includes an identity device and a communication device. The communication device is capable of establishing a near field connection with the identity device, so as to output a control command to the identity device via the near field connection, to obtain contents of a Subscriber Identity Module (SIM) card embedded in the identity device, and execute a wireless communication function of the wireless communication system with the contents of the SIM card.

### BACKGROUND OF THE INVENTION

1. Field of the Invention

The present invention relates to a wireless communication user system, and more particularly, to a wireless communication user system capable of executing wireless communication functions in different communication devices without inserting a Subscriber Identity Module (SIM) card.

2. Description of the Prior Art

The third generation (3G) mobile communication system has introduced a wireless access method of Wideband Code Division Multiple Access (WCDMA), to provide high frequency spectrum utilization, universal coverage, high quality, and high multimedia data transmission rate. WCDMA simultaneously meets all kinds of Quality of Service (QoS) requirements, provides diverse flexible two-way transmission services and provides better communication quality to effectively reduce transmission interruption. Therefore, more and more consumers surf the internet or perform data communication applications via the 3G mobile communication system. Meanwhile, other than a smart phone, more and more electronic products support the data communication function of the 3G mobile communication system. In such a condition, if a user has multiple electronic products supporting the data communication function of the 3G mobile communication system, but only a single data communication account, then the user has to pull out and insert a Subscriber Identity Module (SIM) card provided by a service provider into different electronic products, to execute the data communication function via a specific electronic products.

For example, the user has a smart phone and a tablet computer, both supporting the data communication function of the 3G mobile communication system. If the user has only one SIM card supporting the data communication function, when the user intends to surf the internet via the smart phone, the user has to insert the SIM card into the smart phone. Then, if the user intends to surf the internet via the tablet computer, the user has to remove the SIM card from the smart phone, and insert the SIM card into the tablet computer. Obviously, the procedure is inconvenient and troublesome for the user. Therefore, there is a need for improvement of the prior art.

### SUMMARY OF THE INVENTION

It is therefore an objective of the present invention to provide a wireless communication user system.

The present invention discloses the wireless communication user system for a wireless communication system. The wireless communication system includes an identity device and a communication device. The identity device includes a slot, for containing a Subscriber Identity Module (SIM) card corresponding to the wireless communication system; a reading module, coupled to the slot, for reading the contents of the SIM card according to a control command; and a first near field communication module, coupled to the reading module, for receiving the control command via the near field communication method, and sending the contents of the SIM card read from the reading module. The communication device includes a second near field communication module, for establishing a near field communication connection with the first near field communication module; and a wireless communication processing module, coupled to the second near field communication module, for outputting the control command to the identity device via the near field communication connection, to obtain the contents of the SIM card, and executing a wireless communication function of the wireless communication system with the contents of the SIM card.

The present invention further discloses the wireless communication user system for the wireless communication system. The wireless communication system includes an identity device and a plurality of communication devices. The identity device includes a slot, for containing a SIM card corresponding to the wireless communication system; a reading module, coupled to the slot, for reading the contents of the SIM card according to a control command; and a first near field communication module, coupled to the reading module, for receiving the control command via the near field communication method, and sending the contents of the SIM card read from the reading module. Each communication device of the plurality of communication devices includes a second near field communication module, for establishing a near field communication connection with the first near field communication module; and a wireless communication processing module, coupled to the second near field communication module, for outputting the control command to the identity device via the near field communication connection, to obtain the contents of the SIM card, and executing the wireless communication function of the wireless communication system with the contents of the SIM card.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a wireless communication user system according to an embodiment of the present invention.

FIG. 2 is a schematic diagram of another wireless communication user system according to an embodiment of the present invention.

### DETAILED DESCRIPTION

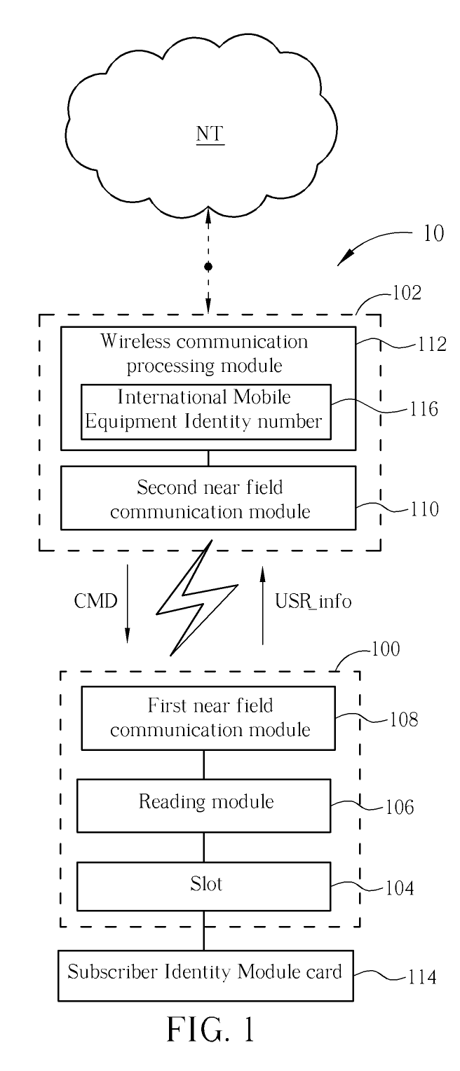

Please refer to FIG. 1, which is a schematic diagram of a wireless communication user system 10 according to an embodiment of the present invention. The wireless communication user system 10 includes an identity device 100 and a communication device 102, and is utilized for accessing a wireless communication system NT, to execute related wireless communication function. In detail, the identity device 100 includes a slot 104, a reading module 106 and a first near field communication module 108. The communication device 102 includes a second near field communication module 110 and a wireless communication processing module 112. The slot 104 contains a Subscriber Identity Module card (SIM card) 114 corresponding to the wireless communication system NT. The SIM card 114 stores information USR_info related to the user or authentication, such as an International Mobile Subscriber Identity (IMSI), etc., for the wireless communication system NT to perform authentication. The first near field communication module 108 and the second near field communication module 110 can utilize the near field communication technique, such as Bluetooth, radio frequency identity (RFID), infrared rays, etc., to establish a near field communication connection, such that the communication device 102 can read the information USR_info stored in the SIM card 114.

In detail, the wireless communication processing module 112 accesses and executes the wireless communication function of the wireless communication system NT, and thus stores an International Mobile Equipment Identity number (IMEI) 116 according to an international standard. When the user intends to access the wireless communication system NT, the user has to pass the authentication of the wireless communication system NT. Therefore, the wireless communication processing module 112 transmits a control command CMD to the reading module 106 via the near field communication connection between the second near field communication module 110 and the first near field communication module 108. The reading module 106 reads the information USR_info of the SIM card 114 according to the control command CMD, and transmits the information USR_info of the SIM card 114 back to the wireless communication processing module 112 via the near field communication connection between the first near field communication module 108 and the second near field communication module 110. Finally, the wireless communication processing module 112 utilizes the information USR_info and the IMEI number 116 for authentication, to start utilizing a wireless communication service provided by the wireless communication system NT.

In a word, in the wireless communication user system 10, the SIM card 114 is set outside the communication device 102, and thus when the communication device 102 intends to perform authentication of the wireless communication system NT, the communication device 102 reads the contents of the SIM card 114 via near field communication. In such a condition, if the SIM card 114 is utilized in a data communication service of the wireless communication system NT, when the user intends to execute data communication via the communication device 102, the user only needs to establish the near field communication connection between the communication device 102 and the identity device 100 to read the contents of the SIM card 114 for authentication, without removing and then inserting the SIM card 114 into the communication device 102. In other words, the user does not need to frequently remove and insert the SIM card 114, but can accurately execute the required wireless communication service via the wireless communication user system 10.

Note that, the wireless communication user system 10 shown in FIG. 1 is an embodiment of the present invention, and those skilled in the art can readily make modifications or alternations. For example, the communication device 102 can be any electronic product with wireless communication function, e.g. a smart phone, a tablet computer, etc., and may include at least one slot and corresponding reading module, for containing and reading the SIM card 114. The wireless communication processing module 112 is only a function block for executing the wireless communication function, and can be composed of multiple elements such as a radio frequency module, a baseband module, a processor, and a memory, etc., depending on system and design requirements. The IMEI number 116 is a sequence number generally acknowledged in the international for identifying each independent communication device in the mobile communication internet, and can be stored in a store unit as the memory, etc. Similarly, the identity device 100 can also include a store unit, for storing another IMEI number.

Besides, in FIG. 1, the identity device 100 is utilized for reading the single SIM card 114, and thus FIG. 1 includes the single slot 104. In practice, the identity device 100 may include multiple slots, for containing different SIM cards (corresponding to different wireless communication systems), and the user or the communication device 102 can decide a SIM card to be read. The derivative applications are known to those skilled in the art.

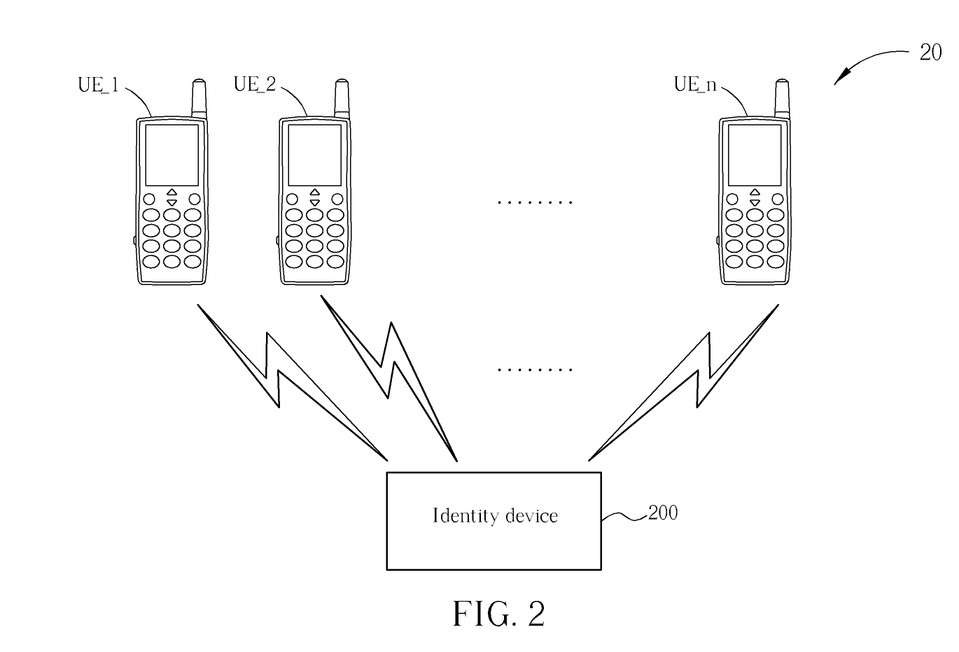

On the other hand, the wireless communication user system 10 only includes the single communication device 102. In practice, in other embodiments, the wireless communication user system of the present invention can further include multiple communication devices. For example, please refer to FIG. 2, which is a schematic diagram of a wireless communication user system 20 according to an embodiment of the present invention. The wireless communication user system 20 is a derived concept of the wireless communication user system 10, and includes an identity device 200 and the communication devices UE_1-UE_n. A structure of the identity device 200 is the same as that of the identity device 100, which can contain at least one SIM card, to provide required information of the wireless communication system for authentication. A structure of each of the communication devices UE_1-UE_n is substantially the same as that of the communication device 102 shown in FIG. 1, which reads the contents of the SIM card embedded in the identity device 200 via near field communication, so as to perform authentication of the wireless communication system, to execute related wireless communication function.

The wireless communication user system 20 is the derived embodiment of the wireless communication user system 10, and the detailed operations and alterations can be derived by referring to the above, and are not narrated hereinafter. In addition, the communication devices UE_1-UE_n can be electronic products with wireless communication function, e.g. smart phones, tablet computers, etc. In such a condition, when the user intends to execute wireless communication function via different communication devices of the wireless communication user system 20, the user only needs to establish the near field communication connection to read the contents of the SIM card embedded in the identity device 200 for authentication, without pulling out and then inserting the SIM card. In other words, the user can execute the required wireless communication service via the wireless communication user system 20 without pulling out and inserting the SIM card between different communication devices.

For example, the user has a smart phone and a tablet computer both supporting data communication function of the 3G mobile communication system. If the user only has one SIM card supporting the data communication function and contained in the identity device of the present invention, when the user intends to surf the internet via the smart phone, the user has to ensure the smart phone can accurately establish near field communication connection with the identity device, such that the user can surf the internet or execute network functions via the smart phone. Then, if the user intends to surf the internet via the tablet computer alternatively, the user only has to ensure the tablet computer can establish near field communication connection with the identity device, such that the user can surf the internet or execute the network functions via the tablet computer. As can be seen, the present invention can enhance convenience effectively.

To sum up, the present invention transmits the contents of the SIM card via near field communication, such that the user can execute wireless communication function in different communication devices without frequently pulling out and inserting the SIM card.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A wireless communication user system for a wireless communication system, comprising:
an identity device, comprising:
a slot, for containing a Subscriber Identity Module (SIM) card corresponding to the wireless communication system;
a reading module, coupled to the slot, for reading contents of the SIM card according to a control command; and
a first near field communication module, coupled to the reading module, for receiving the control command via the near field communication method, and sending the contents of the SIM card read from the reading module; and
a communication device, comprising:
a second near field communication module, for establishing a near field communication connection with the first near field communication module; and
a wireless communication processing module, coupled to the second near field communication module, for outputting the control command to the identity device via the near field communication connection, to obtain the contents of the SIM card, and executing a wireless communication function of the wireless communication system with the contents of the SIM card.

2. The wireless communication user system of claim 1, wherein the wireless communication function is a data communication function.

3. The wireless communication user system of claim 1, wherein the wireless communication system is a 3G communication system.

4. The wireless communication user system of claim 1, wherein the communication device further comprises a storage unit, for storing an International Mobile Equipment Identity number (IMEI), and the wireless communication processing module further executes the wireless communication function with the contents of the SIM card and the IMEI.

5. The wireless communication user system of claim 4, wherein the identity device further comprises a storage unit, for storing another IMEI.

6. The wireless communication user system of claim 1, wherein the first near field communication module and the second near field communication module comply with Bluetooth communication standard.

7. The wireless communication user system of claim 1, wherein the identity device further comprises a plurality of ancillary slots, for containing a plurality of SIM cards corresponding to at least one wireless communication system.

8. A wireless communication user system for a wireless communication system, comprising:
an identity device, comprising:
a slot, for containing a Subscriber Identity Module (SIM) card corresponding to the wireless communication system;
a reading module, coupled to the slot, for reading contents of the SIM card according to a control command; and
a first near field communication module, coupled to the reading module, for receiving the control command via the near field communication method, and sending the contents of the SIM card read from the reading module; and
a plurality of communication devices, each comprising:
a second near field communication module, for establishing a near field communication connection with the first near field communication module; and
a wireless communication processing module, coupled to the second near field communication module, for outputting the control command to the identity device via the near field communication connection, to obtain the contents of the SIM card, and executing a wireless communication function of the wireless communication system with the contents of the SIM card.

9. The wireless communication user system of claim 8, wherein the wireless communication function is a data communication function.

10. The wireless communication user system of claim 8, wherein the wireless communication system is a 3G communication system.

11. The wireless communication user system of claim 8, wherein the each communication device further comprises a storage unit, for storing an International Mobile Equipment Identity number (IMEI), and the each communication device of the wireless communication processing module further executes the wireless communication function with the contents of the SIM card and the IMEI.

12. The wireless communication user system of claim 11, wherein the identity device further comprises a storage unit, for storing another IMEI.

13. The wireless communication user system of claim 8, wherein the first near field communication module and the second near field communication module comply with Bluetooth communication standard.

14. The wireless communication user system of claim 8, wherein the identity device further comprises a plurality of ancillary slots, for containing a plurality of SIM cards corresponding to at least one wireless communication system.
